(19) United States
(12) Patent Application Publication
(10) Pub. No.: US 2022/0112051 A1
(43) Pub. Date: Apr. 14, 2022

(54) MONITORING SYSTEM FOR CONVEYANCE SYSTEM

(71) Applicant: Otis Elevator Company, Farmington, CT (US)

(72) Inventors: Antoine Blanchard, Gien (FR); Romain Marechal, Gien (FR); Karl D. Pedersen, Terryville, CT (US)

(21) Appl. No.: 17/404,134

(22) Filed: Aug. 17, 2021

(30) Foreign Application Priority Data
Oct. 14, 2020 (EP) 20306203.9

(51) Int. Cl. B66B 5/00; B66B 13/14

(52) U.S. Cl. CPC B66B 5/0025; B66B 13/146; B66B 5/0031

(57) ABSTRACT

A monitoring system for a conveyance system includes a pressure sensor mounted on a conveyance apparatus; an accelerometer mounted on the conveyance apparatus; and a controller arranged to: acquire accelerometer data by sampling the accelerometer; store the accelerometer data in a buffer; acquire pressure sensor data by sampling the pressure sensor; determine from the pressure sensor data that a start or stop of the conveyance apparatus has occurred; and upon said determination, analyse the accelerometer data to determine a first position within the accelerometer data, wherein the first position is a position at which the start or stop of the conveyance apparatus occurred. Both pressure and acceleration readings are combined to determine a point in time at which motion started or stopped. The pressure sensor is used first to determine a robust indication that the motion state has changed (started or stopped).

### FOREIGN PRIORITY

This application claims priority to European Patent Application No. 20306203.9, filed Oct. 14, 2020, and all the benefits accruing therefrom under 35 U.S.C. § 119, the contents of which in its entirety are herein incorporated by reference.

### TECHNICAL FIELD

This disclosure generally relates to a conveyance system, and specifically to a method and apparatus for monitoring motion of a conveyance apparatus, in particular, a direction of motion and/or a starting and/or stopping time of a conveyance apparatus within a conveyance system.

### BACKGROUND

It is known to monitor the position and direction of motion of a conveyance apparatus within conveyance systems, such as, for example, elevator systems, escalator systems, and moving walkways. Typically, position and direction may be determined using various position determination mechanisms such as rotary encoders in the drive system or coded tapes provided along the length of the conveyance system (e.g. along the length of a hoistway in an elevator system) with a corresponding tape reader (e.g. mounted on an elevator car). Position in an elevator system can also be detected using vanes mounted in a hoistway (e.g. in the vicinity of landings) and light sensors on the car which are interrupted by the presence of a vane.

### SUMMARY

According to a first aspect of this disclosure there is provided a monitoring system for a conveyance system, comprising: a pressure sensor mounted on a conveyance apparatus; an accelerometer mounted on the conveyance apparatus; and a controller arranged to: acquire accelerometer data by sampling the accelerometer; store the accelerometer data in a buffer; acquire pressure sensor data by sampling the pressure sensor; determine from the pressure sensor data that a start or stop of the conveyance apparatus has occurred; and upon said determination, analyse the accelerometer data to determine a first position within the accelerometer data, wherein the first position is a position at which the start or stop of the conveyance apparatus occurred.

Accurate determination of the motion of a conveyance apparatus (e.g. direction of travel and whether it is moving or not) can be difficult and/or expensive. This is especially true in systems in which direct access to the drive machinery is not possible, and in which the position and direction of motion of the conveyance apparatus must be determined indirectly. This may be the case for example in condition based maintenance systems which may be retro-fitted to older conveyance systems without being communicatively connected to the drive and/or control systems. Such systems operate off independent sensors which may be independently powered (e.g. by battery or energy harvesting systems) and which communicate diagnostic and/or analysis data to a monitoring server using wireless communications. The monitoring server may be situated locally (on-site) or external (off-site), e.g. a cloud-based server.

Such condition based maintenance detectors typically employ sensors which detect various characteristics of the conveyance system. For example they may include accelerometers to detect vibratory signatures associated with certain operations which can be compared against expected vibratory signatures to determine if those operations are functioning correctly. Additionally, microphones can detect sound signatures associated with certain operations and/or faults and light sensors can determine lighting characteristics and faults. Accelerometers may be provided as part of an inertial measurement unit (IMU) which may also include gyroscopes. While such sensors typically include a vertical accelerometer (i.e. one oriented to sense acceleration along the vertical axis), it is difficult to use such sensors directly to determine when the conveyance apparatus starts and stops movement. The raw sensor data may be noisy and is typically sampled at a low rate (to conserve power) such that accurate detection of an acceleration associated with the start or stop of movement is not straightforward. Moreover, the signal processing required to detect a start or stop from just the accelerometer data is typically intense and consumes significant power which is unattractive especially in independently powered devices. A pressure sensor on the other hand provides a robust indication that motion has changed, e.g. that motion has started or stopped by giving a simple and well-defined output that indicates a significant change in pressure (height) or an insignificant change in pressure (height). It will be appreciated that over the short term in which conveyance systems start and stop motion, pressure and height are essentially equivalent as atmospheric pressure changes (e.g. due to changing weather systems) are on a much slower scale. The pressure sensor, while robust and easily measurable, is still not accurate in terms of establishing a time at which motion changed. The accuracy of the readings from the pressure sensor may be of the order of plus or minus half a meter, such that a change in height of at least this magnitude (and preferably more) must be used to establish a reliable indication of motion. Even if the pressure sensor is sampled at a high sampling rate, the accuracy of the readings prevents an accurate calculation of the time at which motion actually commenced or ceased.

Determining an accurate time at which the motion started or stopped is important for analysing the behaviour and characteristics of the system and can therefore be important in a condition based maintenance system to assist with making the appropriate analysis of the sensor information. For example, accelerometer readings on an elevator while the elevator is stationary at a landing are indicative of the behaviour and characteristics of the door as it opens and closes. On the other hand, those same accelerometer readings while the elevator is in motion between landings are indicative of the car drive and guidance systems, e.g. the health of the rollers and guiderails. The time between the doors closing and the elevator car starting to move is very short (so as to minimise passenger journey times) so it is important to be able to separate the door acceleration data from the car acceleration data by determining the time at which the car starts to move. If an inaccurate estimate of the car motion start time is made then car vibrations may incorrectly be attributed to door health or door vibrations may incorrectly be attributed to roller or guiderail health (for example). The same applies when the elevator car stops moving except that in some elevator systems the doors may even start to open before the elevator has stopped moving (termed “Advanced Door Opening”) such that there may even be some overlap in which detected accelerations may be attributable to both the door and the car.

According to this disclosure, both pressure and acceleration readings are combined to determine a point in time at which motion started or stopped. The pressure sensor is used first to determine a robust indication that the motion state has changed (started or stopped). Upon making that determination, the accelerometer data is then analysed to make an accurate determination of when the motion state changed (i.e. when the conveyance apparatus started or stopped). The processing that is required to extract an accurate start or stop time from the accelerometer data is sufficiently intensive and power consuming that it cannot be run continuously on a low power (e.g. battery powered or energy harvesting) device. However the pressure sensor detection part of the process is low powered and is used to trigger the accelerometer processing only when necessary, such that the overall detection process is energy efficient as well as accurate.

It will be appreciated that the determination of a time at which motion of the conveyance apparatus started or stopped may be an absolute time or a relative time. The time may be relative to a time at which the accelerometer analysis is triggered (i.e. the time at which the controller determines from the pressure sensor data that a start or stop has occurred). This may conveniently be expressed in terms of a number of samples in the accelerometer data, e.g. an index within the buffer. Such a measurement may of course be readily converted to an actual time measurement using the known sample rate.

Determining the start or stop of the conveyance apparatus from the pressure sensor may simply require noting of a change in pressure. However, occasional small pressure variations may trigger a small change without being indicative of a change in movement. Therefore in some examples the controller is arranged to determine that a start or stop of the conveyance apparatus has occurred based on detecting a change in the pressure data of at least a threshold amount within a predetermined period of time. For example, a pressure change corresponding to at least 1.5 metres may be required within a time period of 4 seconds to be considered significant. Of course these numbers are given by way of example only. The threshold may be chosen to be large enough that false positive motion detections are unlikely, while being small enough that the change is detected swiftly which minimises the amount of accelerometer data that needs to be buffered.

The controller may be arranged to analyse any suitable amount of accelerometer data or even all available data. However, in some examples the controller is arranged to analyse a recent time window of the accelerometer data. The recent time window may be a set of the most recent accelerometer samples, i.e. starting from the most recent sample and extending back through a predetermined number of samples that define the length of the window. The window may be the same size as the buffer so that the window contains all of the data within the buffer or it may be a subset of the buffer. In some examples the window begins at the most recent accelerometer sample, but this need not be the case as the delay in determining a change in motion through the pressure sensor will likely mean that the start or stop occurred a few seconds earlier such that some of the most recent accelerometer samples may not be required for processing. The length of the window may be chosen to be long enough to provide reliable identification of the change of motion, but short enough to keep the processing fast and energy efficient. In some examples the recent time window may have a length of at least 20 samples, or at least 30 samples or at least 50 samples. In some examples the time window may have a length of no more than 200 samples, or no more than 150 samples or no more than 100 samples. However, it will be appreciated that in other examples a higher sampling rate may be used and the time window may have a greater length, e.g. up to 1000 samples or more. The time length of the window will, more generally, depend on the number of samples and the sampling rate. In some examples the time length of the recent time window is at least 2 seconds, or at least 3 seconds or at least 4 seconds. In some examples the time window is no more than 10 seconds, or no more than 8 seconds or no more than 6 seconds. In some examples the time window may be any desired length of time.

Depending on the nature of the accelerometer data, it may be possible to identify the change of motion without filtering the data. However, accelerometer data is often noisy which complicates the analysis. The acceleration due to a change of motion of the conveyance apparatus is normally smooth and varies at a very low frequency so as to provide a smooth and comfortable ride to passengers. Therefore in some examples the controller is arranged to filter the accelerometer data with a low pass filter. The low pass filter can be selected to cut out all or most of the noise, leaving only the low frequency acceleration data relating to the main drive motion of the conveyance apparatus. The low pass filtered data can then be used in subsequent processing to determine the position within the data at which the start or stop occurred. The low pass filter requires moderately intensive processing and it is therefore desirable not to run this continuously during operation, but rather only when the pressure sensor detects a change in motion. Additionally, as processing of the high frequency data is desired for other purposes (e.g. health analysis and/or condition based maintenance), continuous running of the low pass filter would require storing (buffering) of two sets of data (one high frequency, one low frequency). By using the pressure sensor as a trigger for start/stop analysis, the low pass filtered data can be generated and processed just in response to the trigger rather than requiring continuous buffering in itself. The low pass filter may be steep and very low pass so as to focus on just the acceleration due to the drive profile. In some examples the low pass filter may have a cutoff frequency of no more than 5 Hz, or no more than 3 Hz or no more than 1 Hz. In some examples the low pass filter may be at least a second order filter. In some examples the low pass filter may use forward-backward filtering (it may filter from first sample to last sample and then filter again from last sample to first sample). This avoids altering the phase of the signal. The low pass filter may be a linear phase filter (which generates a constant delay) or a zero phase delay filter. The filter may be a butterworth filter.

It will be appreciated that the drive profile may involve accelerations in a specific, known direction so that the accelerometer data only for that direction can be taken into account. For example, in vertical conveyance systems such as elevator systems the motion profile is a vertical motion profile and therefore the accelerometer data analysed for the start and/or stop may consist of only vertical accelerometer data. It will be appreciated that the sensor may comprise accelerometers oriented in multiple directions, e.g. three mutually orthogonal directions to have full three-dimensional acceleration sensing capability. This may be beneficial for a detailed health analysis of the vibrations. The accelerometer data used to detect the start and/or stop of the conveyance apparatus may however be a vertical component of that three dimensional data. The accelerometer(s) may be part of an inertial measurement unit.

In some examples the controller is arranged to analyse the accelerometer data to find a second position within the accelerometer data, the second position being a position at which the accelerometer data crosses a threshold value and wherein the controller is arranged to determine the first position based on the second position. The controller may be integrated locally within the conveyance system, located remotely or in the cloud, or in some combination thereof. The controller may be configured to analyse the accelerometer data regardless of its location. Depending on the particular situation, this part of analysis may be to identify a point at which the signal rises above a threshold or it may be to identify a point at which the signal drops below a threshold. The analysis may require identifying that the threshold is crossed in a particular direction, e.g. from below the above or from above to below. The threshold may be a positive value or a negative value, depending on the expected direction of acceleration. It will be appreciated that when identifying a threshold crossing in a set of discrete data points, there will be two adjacent data points, one above the threshold and one below the threshold. Either of these data points may be identified as the second position. The first position may be identified as the second position in some examples (e.g. where the threshold is very close to zero it may be assumed that crossing the threshold is equivalent to stopping). In other examples the first position may be determined to be a fixed distance (e.g. a fixed number of samples) away from the second position, e.g. to account for a further expected movement of the conveyance apparatus between the threshold crossing and the stationary state.

In some examples the controller is arranged to analyse the accelerometer data to find a third position within the accelerometer data, the third position being a position at which the accelerometer data reaches a maximum or minimum value and wherein the controller is arranged to determine the first position based on the third position. In many cases, the acceleration profile of a conveyance apparatus will attain a peak acceleration shortly after departing from a stationary position and also just before stopping again. In such cases, there will be a peak (maximum) in the acceleration or a trough (minimum) in acceleration depending on the sign (direction) of the acceleration. If this peak or trough occurs at a well-defined point in the acceleration profile then if the peak or trough can be identified accurately then it may be used to work out an accurate start or stop time for the conveyance apparatus. This may involve identifying a turning point, i.e. a peak in the data set rather than just a high point or low point within the data set. In other examples the identification of the maximum or minimum may be an intermediate step to be followed by further analysis steps. In such cases it may not be necessary to identify a peak, but may be sufficient to identify a simple maximum or minimum within the acceleration data. For example, in some examples it may be desirable to look for certain data features that occur before or after a maximum or minimum. In some examples it may be useful to identify a crossing of a threshold on a particular side of a maximum or minimum, e.g. a point at which the data crosses a threshold value before reaching a maximum (or minimum), or a point at which the data crosses a threshold value after reaching a maximum (or minimum). Thus the above methods of determining a second position within the accelerometer data may be constrained to identify the second position with a particular position (and time) relationship (before or after) the identified third position. In some examples the controller is arranged to determine the second position as a position closest to the third position and on a selected side of the third position at which the accelerometer data crosses the threshold value.

Four particular scenarios may be highlighted here, depending on whether the conveyance apparatus is starting or stopping motion and whether it is travelling upwards or downwards:

First, where the conveyance apparatus is initially stationary and begins moving upwards (positive acceleration), there will be a positive peak acceleration shortly after the start of movement with the acceleration subsequently reducing in magnitude (getting less positive). The third position would be identified as the position of the maximum acceleration and/or the second position may be identified as the position at which the acceleration rises above a positive threshold. In the case where both second and third positions are identified in the analysis, the second position may be identified as the position at which the acceleration crosses the positive threshold before reaching the third position. The first position may be determined to be the second position or a fixed distance from the second position.

Second, where the conveyance apparatus is initially stationary and begins moving downwards (negative acceleration), there will be a negative peak acceleration shortly after the start of movement with the acceleration subsequently reducing in magnitude (getting less negative). The third position would be identified as the position of the minimum acceleration and/or the second position may be identified as the position at which the acceleration drops below a negative threshold. In the case where both second and third positions are identified in the analysis, the second position may be identified as the position at which the acceleration crosses the negative threshold before reaching the third position. The first position may be determined to be the second position or a fixed distance from the second position.

Third, where the conveyance apparatus is initially moving upwards and then stops (negative acceleration), the acceleration will initially increase in magnitude (become more negative) before reaching a negative peak acceleration shortly before the stop of movement. The third position would be identified as the position of the minimum acceleration and/or the second position may be identified as the position at which the acceleration rises above a negative threshold. In the case where both second and third positions are identified in the analysis, the second position may be identified as the position at which the acceleration crosses the negative threshold after reaching the third position. The first position may be determined to be the second position or a fixed distance from the second position.

Fourth, where the conveyance apparatus is initially moving downwards and then stops (positive acceleration), the acceleration will initially increase in magnitude (become more positive) before reaching a positive peak acceleration shortly before the stop of movement. The third position would be identified as the position of the maximum acceleration and/or the second position may be identified as the position at which the acceleration falls below a positive threshold. In the case where both second and third positions are identified in the analysis, the second position may be identified as the position at which the acceleration crosses the positive threshold after reaching the third position. The first position may be determined to be the second position or a fixed distance from the second position.

Having established the position within the accelerometer data at which the start or stop occurred, the monitoring system can use that information to decide how to process other sensor data, including the accelerometer data. It may be noted that, where a low pass filter was used to identify the first, second and/or third positions, it need not be this filtered data that is used in subsequent processing. The raw accelerometer data may be used instead. As noted above, processing may be different at different times in relation to the start and/or stop. For example door closing motion of an elevator car occurs before the start of movement of the car and door opening movement is either fully after the stop of movement of the car or may have an overlap with the car movement (in the case of Advanced Door Opening systems).

In some examples the controller is arranged to associate a motion state of the conveyance apparatus with the accelerometer data, the motion state being an indication of whether the conveyance apparatus is in motion or stationary. Associating the motion state with the data may involve storing a motion state in association with each acceleration data value, i.e. forming a data set in which each time entry (sample entry) comprises an acceleration data value and a motion state value. Other sensor data can also be included so that each time entry (sample entry) comprises an array of several data values. The motion state may be a single bit (e.g. if the motion is considered a binary variable; e.g. ‘in motion’=‘0’, ‘stationary’=‘1’) or it may be a multi-bit value allowing more states to be defined. In some examples the motion state may be associated with the accelerometer data by processing the accelerometer data (e.g. for health analysis) with a fixed time delay. The fixed time delay is greater than the expected time to determine that a change of motion (start or stop) has occurred. When a start or stop is determined, an additional time can be calculated, the additional time being the time difference between the identified start/stop time and the fixed time delay. In other words, the additional time is the amount of time that needs to elapse until the determined start/stop time coincides with the fixed time delay. At this point the motion state can be set according to the new state and is associated with all (delayed) data processing from that point. For example, in a process for determining a start of a conveyance apparatus, the motion state associated with the delayed data processing would initially by ‘stationary’. If the start of the conveyance apparatus is then determined (by processing of the pressure sensor data and accelerometer data as described above) to have occurred 3 seconds ago, and the fixed delay for processing is 5 seconds, then an additional time of 2 seconds is required until the motion state associated with the delayed data processing is changed to ‘in motion’.

As discussed above, once the start or stop of the conveyance apparatus has been determined, this can be used to determine how to process the buffered accelerometer data. In some examples the controller is arranged to segregate the accelerometer data into two or more groups based on the first position. In a simple example the first position may divide the data into one group of data before the first position and another group of data on or after the first position. One group can be associated with the conveyance apparatus being in motion while the other group can be associated with the conveyance apparatus being stationary. In another example, the accelerometer may be divided into three groups with a first group defined as a fixed period ending with the first position, a second group being defined as data before the first group and a third group being define as data after the first group. Such grouping may for example be used in an elevator system with Advanced Door Opening where the first position corresponds to an elevator stop. The first group (having fixed length and terminating at the determined stop) may be associated with an overlap of door motion and car motion. The second group (before the first group) may be associated with only car motion and the third group (after the first group) may be associated with only door motion.

The different groups of data may be processed for many different reasons, but one reason is to determine a health of the system or components of the system. Indicators of health may include the number of times a component (e.g. a door) has been operated, noises or vibrations indicative of wear, time to complete an operation, etc. Accordingly, in some examples the controller is arranged to process the accelerometer data to analyse the health of the conveyance system, wherein said processing is performed with a fixed time delay, and wherein the controller is arranged to change a type of health analysis when the first position in the accelerometer data corresponds to the fixed time delay. As noted above, the change in motion may indicate that certain sensor data such as vibration data from accelerometers or sound data from microphones arises from different sources. For example vibrations originate from door operation when an elevator car is stationary, but arise from interaction with drive and/or hoistway components (e.g. guiderails) when the car is in motion. Thus, in some examples the conveyance system is an elevator system and the controller is arranged to change the type of health analysis from elevator door analysis to elevator car analysis or from elevator car analysis to elevator door analysis.

In some examples the conveyance system is an elevator system and the conveyance apparatus is an elevator car, wherein the elevator system implements an advanced door opening system and wherein when the controller determines a stop of the elevator car, the controller is arranged to determine the first position within the accelerometer data additionally based upon an advanced door opening adjustment. In some examples in which an advanced door opening system is implemented, there is an overlap in time between the elevator car doors opening and the elevator car being in motion, such that the doors begin to open before the elevator car has completely stopped. The advanced door opening adjustment may therefore be selected to move the first position to an earlier position, to account for at least some of the overlap in time in which both the elevator car and the elevator car doors are in motion. This may be used to improve the analysis of accelerometer data acquired during the overlap period, providing better separation of pure door car motion from pure door motion and/or providing better analysis of the overlap period. The amount of the advanced door opening adjustment may be any suitable amount and may be determined based on factors such as the length of advanced door opening overlap period and sampling rate. It may be determined by experiment and/or analysis to give optimum performance of the algorithm.

The monitoring system could be connected to any power source. However, a requirement to connect to main power makes it more difficult to install the system. It is therefore advantageous if the monitoring system can operate independently and can operate off an independent power source. In some examples the monitoring system is powered by a battery or energy harvesting system. An energy harvesting system may for example comprise an inductive charging system or it may comprise a thermal, kinetic or wind-based system. In some examples the monitoring system is not connected to main power. With battery or energy harvesting powered systems, low power operation becomes very important and therefore the amount of intensive processing, the sensor sampling rates and wireless transmission strengths become important factors in achieving a suitably long operational lifetime between servicing.

In some examples the monitoring system is independent from the conveyance system. Again this facilitates installation as no communicative connections to the existing system controllers are required. Health monitoring can thereby be achieved from an independent system and adds a layer of safety on top of the fault detection and monitoring systems within the conveyance system itself.

The sampling rates of the accelerometer and the pressure sensor could be the same, or the pressure sensor could be sampled at a higher rate than the accelerometer. However, the pressure sensor provides less accurate data (e.g. plus or minus half a metre) and is intended to detect large scale movement in a robust fashion. It is therefore acceptable to sample it at a lower rate. The accelerometer can detect very small accelerations (e.g. of the order of milli-g or even micro-g) such as those due to vibrations and can be sampled at a higher rate to attain better resolution data. Therefore, in some examples a sampling rate of the accelerometer is greater than a sampling rate of the pressure sensor. In some examples the sampling rate of the accelerometer is at least two times that of the pressure sensor, or at least three times, or at least five times, or even at least ten times that of the pressure sensor. In some examples, the sampling rate may be at least 20 times, at least 50 times or even at least 100 times that of the pressure sensor. In some examples the pressure sensor may be sampled at about 1 sample per second and the accelerometer may be sampled at around 12 samples per second.

According to a second aspect of the present disclosure, there is provided a method of monitoring a conveyance system, comprising: acquiring accelerometer data by sampling an accelerometer on a conveyance apparatus; storing the accelerometer data in a buffer; acquiring pressure sensor data by sampling a pressure sensor on the conveyance apparatus; determining from the pressure sensor data that a start or stop of the conveyance apparatus has occurred; and upon said determination, analysing the accelerometer data to determine a first position within the accelerometer data, wherein the first position is a position at which the start or stop of the conveyance apparatus occurred.

It will be appreciated that all of the optional or example features discussed above in relation to the monitoring system can equally optionally apply to this method of monitoring a conveyance system.

### BRIEF DESCRIPTION OF THE DRAWINGS

FIG. 1 is a schematic illustration of an elevator system according to examples of the present disclosure;

FIG. 2 is a schematic illustration of a sensor system for the elevator system of FIG. 1, according to examples of the present disclosure;

FIG. 3 is a schematic illustration of the location of a sensor system for the elevator system of FIGS. 1 and 2, according to examples of the present disclosure;

FIG. 4 is a schematic illustration of a sensing unit according to examples of the present disclosure;

FIGS. 5a and 5b are flow charts showing operations carried out in a change of motion detection process according to examples of the present disclosure;

FIG. 6 is a flow chart showing operations carried out according to an initial motion detection process according to examples of the present disclosure;

FIG. 7 is a flow chart showing operations carried out according to an end of motion detection process according to examples of the present disclosure; and

FIGS. 8a-8d show a plot of acceleration data illustrating an acceleration profile of an elevator car, and ways in which acceleration data is stored to a buffer during the initial motion detection process according to examples of the present disclosure.

### DETAILED DESCRIPTION

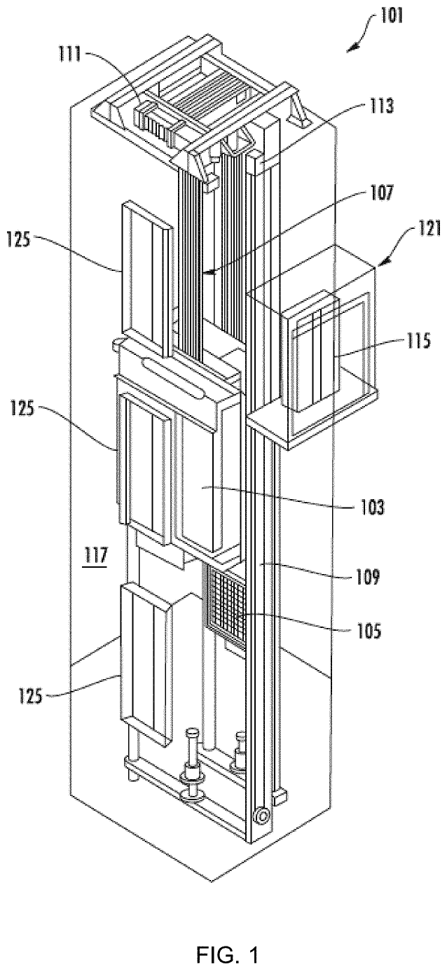

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor or pinched wheel motors to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1. In one example, embodiments disclosed herein may be applicable to conveyance systems such as an elevator system 101 and a conveyance apparatus of the conveyance system such as an elevator car 103 of the elevator system 101. In another example, embodiments disclosed herein may be applicable to conveyance systems such as an escalator system and a conveyance apparatus of the conveyance system such as a moving stair of the escalator system.

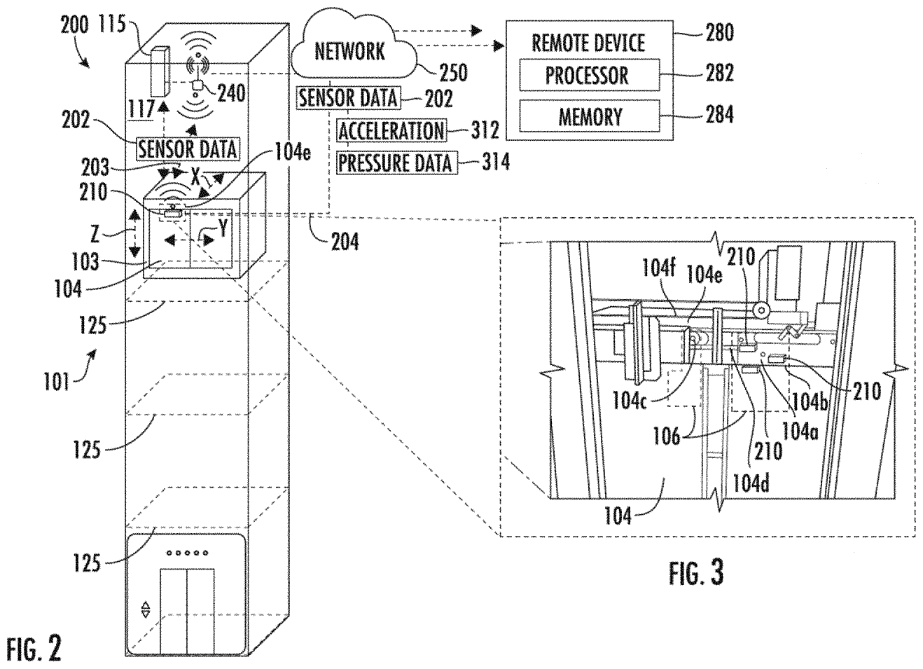

Referring now to FIG. 2, with continued referenced to FIG. 1, a view of a sensor system 200 including a sensing apparatus 210 is illustrated, according to an embodiment of the present disclosure. The sensing apparatus 210 is configured to detect sensor data 202 of the elevator car 103 and transmit the sensor data 202 to a remote device 280. Sensor data 202 may include but is not limited to pressure data 314, vibratory signatures (i.e., vibrations over a period of time) or accelerations 312 and derivatives or integrals of accelerations 312 of the elevator car 103, such as, for example, distance, velocity, jerk, jounce, snap . . . etc. Sensor data 202 may also include light, sound, humidity, and temperature, or any other desired data parameter. The pressure data 314 may include atmospheric air pressure within the elevator shaft 117. It should be appreciated that, although particular systems are separately defined in the schematic block diagrams, each or any of the systems may be otherwise combined or separated via hardware and/or software. For example, the sensing apparatus 210 may be a single sensor or may be multiple separate sensors that are interconnected.

In an embodiment, the sensing apparatus 210 is configured to transmit sensor data 202 that is raw and unprocessed to the controller 115 of the elevator system 101 for processing. In another embodiment, the sensing apparatus 210 is configured to process the sensor data 202 prior to transmitting the sensor data 202 to the controller 115 through a processing method, such as, for example, edge processing. In another embodiment, the sensing apparatus 210 is configured to transmit sensor data 202 that is raw and unprocessed to a remote system 280 for processing. In yet another embodiment, the sensing apparatus 210 is configured to process the sensor data 202 prior to transmitting the sensor data 202 to the remote device 280 through a processing method, such as, for example, edge processing.

The processing of the sensor data 202 may reveal data, such as, for example, a number of elevator door openings/closings, elevator door time, vibrations, vibratory signatures, a number of elevator rides, elevator ride performance, elevator flight time, probable car position (e.g. elevation, floor number), releveling events, rollbacks, elevator car 103 x, y acceleration at a position: (i.e., rail topology), elevator car 103 x, y vibration signatures at a position: (i.e., rail topology), door performance at a landing number, nudging event, vandalism events, emergency stops, etc.

The remote device 280 may be a computing device, such as, for example, a desktop, a cloud based computer, and/or a cloud based artificial intelligence (AI) computing system. The remote device 280 may also be a mobile computing device that is typically carried by a person, such as, for example a smartphone, PDA, smartwatch, tablet, laptop, etc. The remote device 280 may also be two separate devices that are synced together, such as, for example, a cellular phone and a desktop computer synced over an internet connection.

The remote device 280 may be an electronic controller including a processor 282 and an associated memory 284 comprising computer-executable instructions that, when executed by the processor 282, cause the processor 282 to perform various operations. The processor 282 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 284 may be but is not limited to a random access memory (RAM), read only memory (ROM), or other electronic, optical, magnetic or any other computer readable medium.

The sensing apparatus 210 may be configured to transmit the sensor data 202 to the controller 115 or the remote device 280 via short-range wireless protocols 203 and/or long-range wireless protocols 204. Short-range wireless protocols 203 may include but are not limited to Bluetooth, Wi-Fi, HaLow (801.11ah), zWave, ZigBee, or Wireless M-Bus. Using short-range wireless protocols 203, the sensing apparatus 210 is configured to transmit the sensor data 202 directly to the controller 115 or to a local gateway device 240 and the local gateway device 240 is configured to transmit the sensor data 202 to the remote device 280 through a network 250 or to the controller 115. The network 250 may be a computing network, such as, for example, a cloud computing network, cellular network, or any other computing network known to one of skill in the art. Using long-range wireless protocols 204, the sensing apparatus 210 may be configured to transmit the sensor data 202 to the remote device 280 through a network 250. Long-range wireless protocols 204 may include but are not limited to cellular, satellite, LTE (NB-IoT, CAT M1), LoRa, Satellite, Ingenu, or SigFox.

The sensing apparatus 210 may be configured to detect sensor data 202 including acceleration in any number of directions. In an embodiment, the sensing apparatus may detect sensor data 202 including accelerations 312 along three axes, an X axis, a Y axis, and a Z axis, as show in in FIG. 2. The X axis may be perpendicular to the doors 104 of the elevator car 103, as shown in FIG. 2. The Y axis may be parallel to the doors 104 of the elevator car 103, as shown in FIG. 2. The Z axis may be aligned vertically parallel with the elevator shaft 117 and the pull of gravity, as shown in FIG. 2. The acceleration data 312 may reveal vibratory signatures generated along the X-axis, the Y-axis, and the Z-axis.

FIG. 3 shows a possible installation location of the sensing apparatus 210 within the elevator system 101. The sensing apparatus 210 may include a magnet (not show) to removably attach to the elevator car 103. In the illustrated embodiment shown in FIG. 3, the sensing apparatus 210 may be installed on the door hanger 104a and/or the door 104 of the elevator system 101. It is understood that the sensing apparatus 210 may also be installed in other locations other than the door hanger 104a and the door 104 of the elevator system 101. It is also understood that multiple sensing apparatus 210 are illustrated in FIG. 3 to show various locations of the sensing apparatus 210 and the embodiments disclosed herein may include one or more sensing apparatus 210. In another embodiment, the sensing apparatus 210 may be attached to a door header 104e of a door 104 of the elevator car 103. In another embodiment, the sensing apparatus 210 may be located on a door header 104e proximate a top portion 104f of the elevator car 103. In another embodiment, the sensing apparatus 210 is installed elsewhere on the elevator car 103, such as, for example, directly on the door 104.

As shown in FIG. 3, the sensing apparatus 201 may be located on the elevator car 103 in the selected areas 106, as shown in FIG. 3. The doors 104 are operably connected to the door header 104e through a door hanger 104a located proximate a top portion 104b of the door 104. The door hanger 104a includes guide wheels 104c that allow the door 104 to slide open and closed along a guide rail 104d on the door header 104e. Advantageously, the door hanger 104a is an easy to access area to attach the sensing apparatus 210 because the door hanger 104a is accessible when the elevator car 103 is at landing 125 and the elevator door 104 is open. Thus, installation of the sensing apparatus 210 is possible without taking special measures to take control over the elevator car 103. For example, the additional safety of an emergency door stop to hold the elevator door 104 open is not necessary as door 104 opening at landing 125 is a normal operation mode. The door hanger 104a also provides ample clearance for the sensing apparatus 210 during operation of the elevator car 103, such as, for example, door 104 opening and closing. Due to the mounting location of the sensing apparatus 210 on the door hanger 104a, the sensing apparatus 210 may detect open and close motions (i.e., acceleration) of the door 104 of the elevator car 103 and a door at the landing 125. Additionally mounting the sensing apparatus 210 on the hanger 104a allows for recording of a ride quality of the elevator car 103.

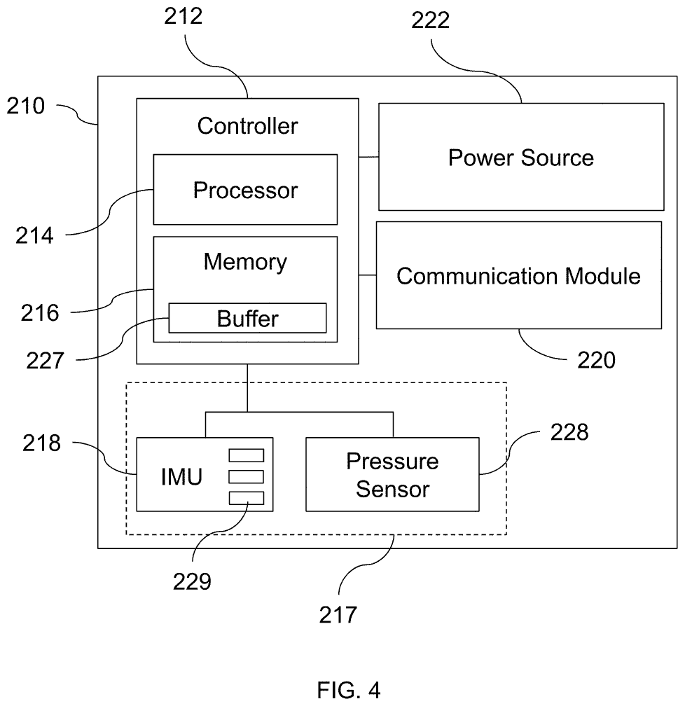

FIG. 4 illustrates an example of a sensing apparatus 210 of FIGS. 2 and 3 in more detail. The sensing apparatus includes a controller 212, a plurality of sensors 217 in communication with the controller 212, a communication module 220 in communication with the controller 212, and a power source 222 electrically connected to the controller 212. The plurality of sensors 217 includes an inertial measurement unit (IMU) 218 and a pressure sensor 228. The IMU 218 comprises three accelerometers 229 and is configured to detect acceleration of the elevator car 103, and to generate the acceleration data 312. The pressure sensor 228 (which may be, for example a pressure altimeter or a barometric altimeter) is configured to detect an atmospheric air pressure within the elevator hoistway 117, and to generate the pressure data 314. Both the IMU 218 and the pressure sensor 228 are in communication with the controller 212 of the sensing apparatus 210. In some examples, the plurality of sensors 217 may also include additional sensors such as a light sensor, a microphone, a humidity sensor, and a temperature sensor.

The power source 222 of the sensing apparatus 210 is configured to store and supply electrical power to the sensing apparatus 210. The power source 222 may include an energy storage system, such as a battery or a capacitor, or other appropriate energy storage system known in the art.

The communication module 220 is configured to allow the controller 212 of the sensing apparatus 210 to communicate with the remote device 280 and/or controller 115 through at least one of short-range wireless protocols 203 and long-range wireless protocols 204 as described above.

The controller 212 of the sensing apparatus 210 includes a processor 214 and a memory 216 comprising computer-executable instructions that, when executed by the processor 214, cause the processor 214 to perform various operations such as processing of the sensor data 202 collected by the IMU 218 and the pressure sensor 228 to determine information about the motion of the elevator car 103. The sensing apparatus 210 also comprises a buffer 227, configured to store a pre-set number of data entries.

The system shown in FIGS. 2 and 3 may be used to monitor the elevator system 101. As described previously, sensor data 202 is measured in a raw, unprocessed form, and processing of the sensor data 202 may reveal data about the elevator system 101. For example, processing of acceleration data 312 may allow faults in the elevator system 101 to be identified. However, for the correct processing methods to be applied, it is necessary to know whether the acceleration data 312 being processed relates to an elevator car 103 that is stationary or an elevator car 103 that is in motion, as well as the direction of the motion of the elevator car 103. This is required to separate acceleration signals due to the motion of the elevator car 103 itself from acceleration signals due to, e.g. movement of the doors 104 of the elevator car 103.

In certain examples, to allow appropriate processing of the acceleration data 312, it is convenient to set a flag indicating a state of motion of the elevator car 103, and to process the acceleration data 312 in accordance with the flag. Accurate determination of the state of motion of the elevator car 103 is therefore useful.

The start and stop of elevator movement (i.e. a change of state between ‘in motion’ and ‘stationary’) provide good dividing points for separating the data relating to the door operation and the data relating to car movement. However, the start and stop can also be used in elevator systems employing “advanced door opening” technology, in which there is an overlap in time between the elevator car doors opening and the elevator car being in motion (i.e. the doors begin to open before the car comes to a complete stop). The start of elevator car motion is still generally a clear separator between the end of a door closing operation and the start of elevator car motion. The stop of elevator car motion can be used together with a known overlap window (e.g. a window of predetermined length) to separate pure door car motion from pure door motion. It will be appreciated that a similar overlap window could also be used at the start of elevator motion for other reasons, for example to take account of other sources of vibration such as an advanced brake lift operation which may overlap with the door motion and/or car motion.

Processes for monitoring motion of a conveyance apparatus (e.g. an elevator car) may be improved by using pressure data 314 to detect that a change in motion of the conveyance apparatus has occurred, and then analysing buffered acceleration data 312 only once a change in motion has been detected in order to determine more accurately when the change of motion of the conveyance apparatus occurred.

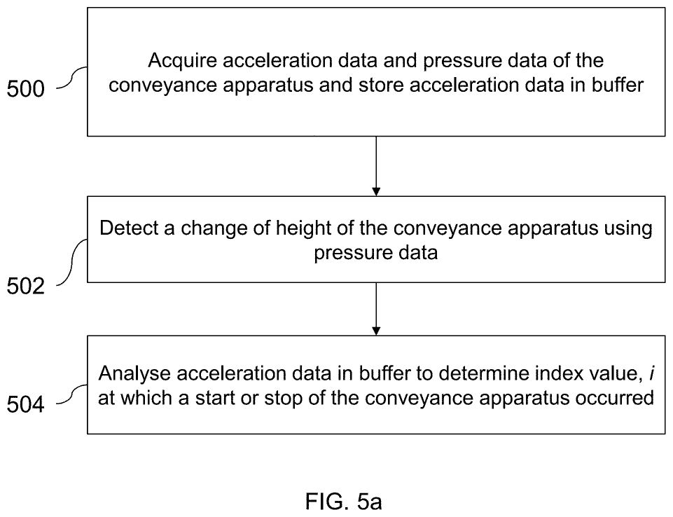

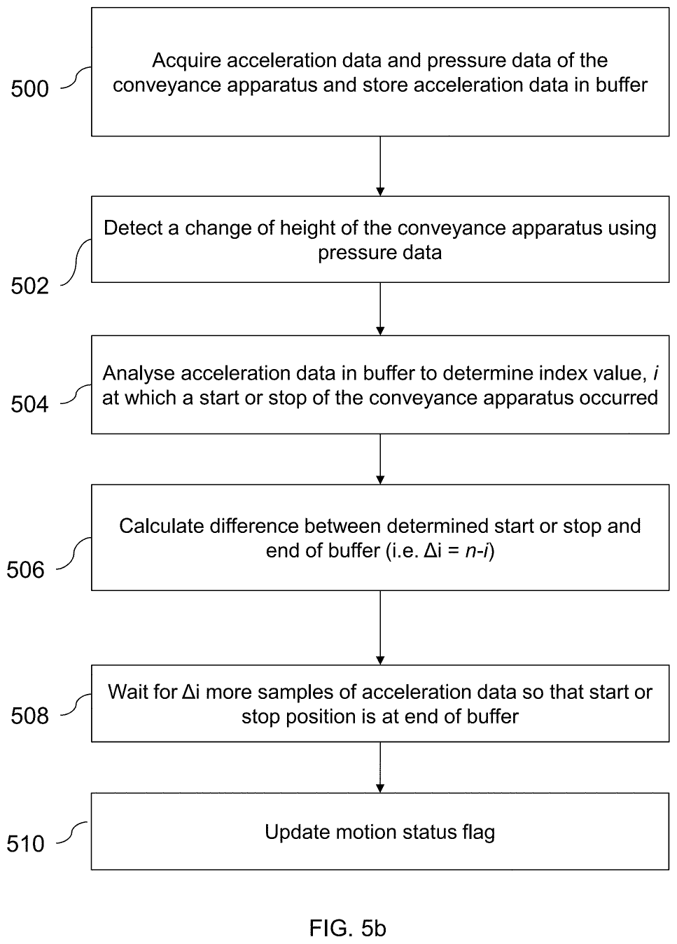

A process for monitoring the motion of a conveyance apparatus in a conveyance system in accordance with examples of the present disclosure will now be described with reference to FIG. 5a.

In the examples described herein, the conveyance system is an elevator system 101 and the conveyance apparatus is an elevator car 103. However it will be appreciated that the same process could equally be applied to a range of conveyance systems including escalator systems and moving walkways. The process illustrated in FIG. 5 may be performed by one or more of the sensing apparatus 210, the controller 115, and the remote device 280, using data from the sensing apparatus 210 as will be described in the following.

At block 500, the acceleration of the elevator car 103 is measured using the IMU 218 and acceleration data 312 is stored in the memory 216 of the sensing apparatus 210. The acceleration of the elevator car 103 is measured at a particular sampling frequency, for example 12 samples per second. In one example, any desired sampling frequency may be used. The acceleration data 312 stored in the memory 216 of the sensing apparatus 210 is saved, at least temporarily, in a buffer 227. The buffer 227 has size of at least n+1, i.e. it is configured to store at least n+1 data values, corresponding to the n+1 most recent acceleration measurements. Each acceleration measurement stored in the buffer 227 has an associated index between 0 and n, with the most recent entry in the buffer 227 having index 0, and the oldest entry in the buffer 227 having index n. As each new acceleration measurement is saved to the buffer 227, the index of each of the previous entries is increased by one, and the entry having index n is removed from the buffer 227. In this way, a series of the n+1 most recent acceleration measurements is temporarily stored in the buffer 227, and the series is updated with each new acceleration measurement saved to the buffer 227. The size of the buffer 227 may be chosen based on characteristics of the elevator system 101, for example based on an expected acceleration behaviour of the elevator car 103, and/or based on a desired update frequency of acceleration measurements from the IMU 218. By way of example, the buffer 227 may be implemented as a shift register or it may be implemented as a sliding window within a larger area of memory.

At block 502, a change of height of the elevator car 103 is determined using the pressure sensor 228 of the sensor apparatus 210. The pressure sensor 228 measures atmospheric air pressure in the vicinity of the elevator car 103 at a sample rate, for example 1 sample per second, and determines whether the height of the elevator car 103 has changed based on the measured pressure. The sample rate at which pressure measurements are taken may be significantly lower than that at which acceleration measurements are taken. A determination of a change in height of the elevator car 103 may be made, for example, by comparing the measured air pressure to a previously measured air pressure value saved in the memory 216 of the sensing apparatus 210, and calculating the difference. The difference in air pressure may be compared to a threshold, and if this threshold is exceeded it may be determined that the height of the elevator car 103 has changed, corresponding to a change in motion of the elevator car 103. This change of height over time does not need to be from adjacent pressure samples, but could span several samples. For example a change of 1.5 m in the space of 4 seconds may be considered to robustly identify that a change of motion has occurred. The process then continues to block 504.

In block 504, the acceleration measurements stored in the buffer 227 are analysed to determine a position (or index value, i) within the accelerometer data which corresponds to a change of motion (i.e. a start or stop) of the elevator car 103.

This analysis in step 504 may be achieved by determining a second position within the accelerometer data at which the acceleration crosses a threshold value. The threshold value may be chosen to be a value small enough to indicate that the elevator car 103 has just started moving, or is about to stop moving, but large enough to avoid being triggered by sensor noise. The analysis in step 504 may also involve determining a third position within the accelerometer data at which a maximum or minimum value of the accelerometer data is reached. This third position may be determined prior to determining the second position. In such cases a further constraint may be placed upon the determination of the second position, e.g. that the threshold value is crossed on a particular side of (i.e. before or after) the maximum or minimum. For example it may be desirable to determine the point at which the acceleration threshold is crossed before attaining a maximum value (and thereby excluding from processing any possible threshold crossing after the maximum value).

The processing of the accelerometer data depends on the type of change of motion that is being determined, e.g. whether the change of motion corresponds to a start or stop of the elevator car 103, and also depends on whether the elevator car 103 is (or was) travelling up or down in the hoistway 117.

As the accelerometer data which corresponds to the start and stop of the elevator car 103 is low frequency, a very steep, very low pass filter (i.e. one having a low cutoff frequency and a steep frequency transition) may first be applied to the acceleration measurements stored in the buffer 227. The filter ideally has minimum or linear phase delay. This filter removes high frequency contributions from noise and other vibrations, thereby simplifying the processing of the acceleration measurements stored in the buffer 227.

FIG. 5b is similar to FIG. 5a, but shows additional steps according to one example for additional analysis of the accelerometer data. After identifying the start or stop of the conveyance apparatus (e.g. elevator car 103) in step 504, the process calculates the difference between the identified start or stop (i.e. the first position) and the end of the buffer (representing the oldest data element). This difference (Δi) represents the number of new samples of accelerometer data that must be acquired before the first position (the start or stop) reaches the end of the buffer. When this happens, it is known that a fixed time (corresponding to the length of the buffer 227) has elapsed since the start or stop occurred. Older accelerometer data (i.e. older than the length of the buffer) can then be processed with certainty as to the motion state of the elevator car 103 at that time. Therefore, in step 508 the system waits for Δi more accelerometer samples so that the start or stop is at the end of the buffer 227 and in step 510 the system updates a motion status flag that indicates whether the conveyance apparatus is “in motion” or “stationary”.

As an example of the processing of FIG. 5b, in the case where an elevator car 103 starts to move away from a stationary position, the processing of steps 500, 502 and 504 will begin with the motion status flag set to “stationary” and will identify an index i at which the start occurred. The system then acquires further accelerometer samples, loading them into one end of the buffer and moving all other data along the buffer (but making no change to the motion status flag) until the start has reached index n in the buffer. Only at this point is the motion status flag updated from “stationary” to “in motion”. Up until this point, data older than the buffer length is known to correspond to a stationary state as indicated by the motion status flag. The update of flag status indicates that this is no longer the case and therefore that data older than the buffer length can no longer be taken as purely “stationary” data. This allows simple processing of the accelerometer data using a fixed processing delay. While it is convenient to have the processing delay correspond to the length of the buffer 227 as described here, it will be appreciated that this need not be the case and that a longer or shorter fixed processing delay can be used so long as it is long enough to ensure that the start or stop reliably occurs before the fixed processing delay.

The processing of the accelerometer data after the fixed processing delay may be used to analyse the health of one or more components of the conveyance system. For example, if it is determined that, subsequent to an identified change of motion, the elevator car 103 is in motion, raw (i.e. unfiltered) acceleration data may be processed to determine the condition of the elevator car 103 and guiderails within the shaft 117. Similarly, if the elevator car 103 is determined to be stationary, it is likely that any measured acceleration will be caused by the doors 104 of the elevator car 103. As such, raw acceleration data obtained when the elevator car 103 is at rest may be processed to determine the condition of the elevator car doors 104. Such processed data may be transmitted to the remote device 280 using short-range wireless protocols 203 and/or long-range wireless protocols 204 to allow any faults with the elevator system 101 to be identified without requiring, for example, manual inspection of the elevator system 101. Such analysis may also be used by a condition based maintenance system to predict and schedule maintenance of the system 101.

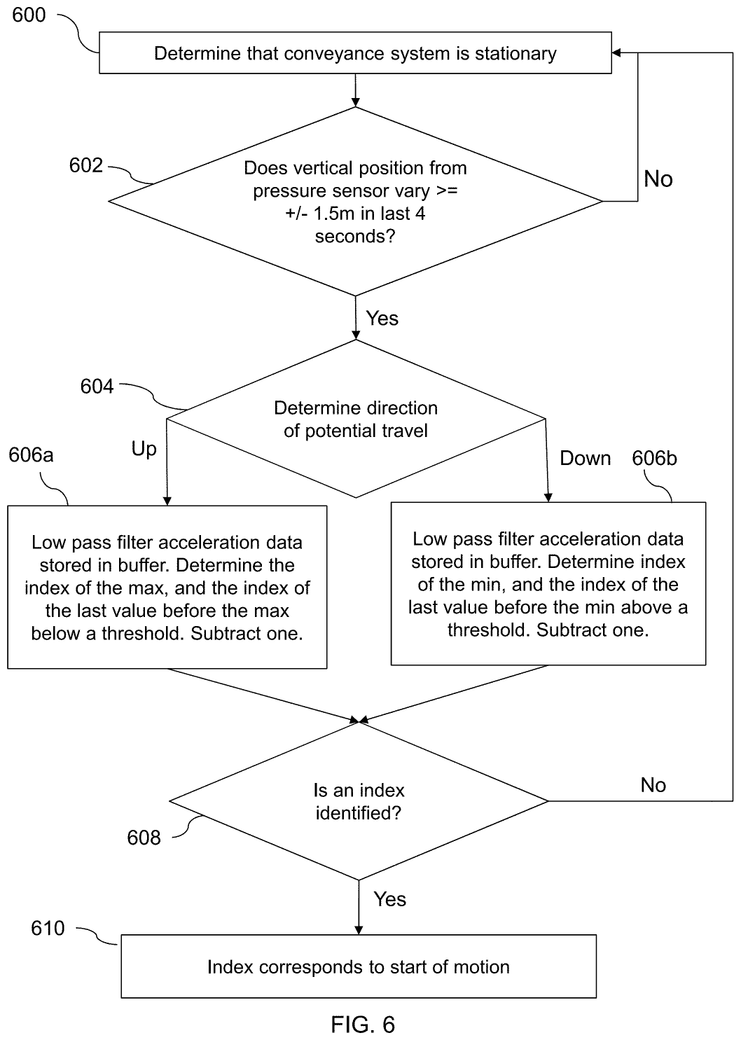

Having described the general process for determining a change in motion of an elevator car 103 with reference to FIGS. 5a and 5b, two specific scenarios will be described with reference to FIGS. 6 to 8.

FIG. 6 shows a process for determining a start of motion of the elevator car 103 in accordance with the present disclosure. In block 600, it is determined that the elevator car 103 is stationary (i.e. the motion status flag indicates that the elevator car 103 is not in motion). In block 602, a change of pressure is determined by using the pressure sensor 228 of the sensor apparatus 210 as described previously. Based on the change of pressure, a change in height of the elevator car 103 is calculated. If the change of height in a given time period is greater than a threshold value (e.g. 1.5 metres within 4 seconds), the process continues to block 604, in which a direction of travel is determined, for example based on the sign of the change in height. Based on the direction of travel, the process continues to block 606a or block 606b if the direction of travel is upwards or downwards respectively. It will be appreciated that calculation of a change in height is not strictly required, and in some embodiments the measured change of pressure may be compared to a threshold in place of a change of height.

If it is determined that the change in height was in a vertically upward direction, the process continues to block 606a. In block 606a, a low pass filter is applied to the acceleration measurements stored in the buffer 227. The index of the maximum acceleration value iₘₐₓ, is then identified. To determine the index associated with the start of motion, the acceleration measurements stored in the buffer 227 with an index greater than the index i_{max¬}of the maximum acceleration value (i.e. older measurements) are compared to a threshold upward acceleration value a₁ (for example 10 mg) in order of increasing index value. The index iᵤₚ of the first acceleration value lower than the threshold acceleration value a₁ is then identified, and the index iᵤₚ-1 is determined to be the index associated with the start of motion. The decrement by 1 in this example is to select the value at which the acceleration is above the threshold rather than the value that is below the threshold (lower index values represent newer measurements), but in other examples this decrement could be omitted. In block 608, if none of the acceleration values stored in the buffer 227 are determined to be below the threshold acceleration value a₁, then it is likely that a start has not taken place, perhaps due to an error in the pressure readings or the like. If however, an index iᵤₚ-1 is identified, then a determination is made that the elevator car 103 is in motion, and the position within the accelerometer data at which the upward motion started is identified in block 610 based on the identified index iᵤₚ-1. As discussed above in relation to FIG. 5b, a motion status flag may then be set indicating that the elevator car 103 is in motion. In some examples, having identified the index iᵤₚ−1 at which the motion of the elevator car 103 began, the system waits until the identified index iᵤₚ−1 moves to the final position (n) of the buffer 227, and then changes the flag state from 0 to 1 (i.e. from “stationary” to “in motion”).

If however, it is determined in step 604 that the change in height was in a vertically downward direction, the process continues to block 606b. In block 606b, a low pass filter is applied to the acceleration measurements stored in the buffer 227. The index of the minimum acceleration value i_{min¬} is then identified. To determine the index associated with the start of motion, the acceleration measurements stored in the buffer 227 with an index greater than the index iₘᵢₙ of the minimum acceleration value (i.e. older measurements) are compared to a threshold acceleration value in the downward direction a1 (e.g. −10 mg) in order of increasing index value. The index i_{down} of the first acceleration value greater than the threshold acceleration value a₁ is then identified, and the index i_{down}−1 is determined to be the index associated with the start of motion. The decrement by 1 in this example is to select the value at which the acceleration is above the threshold rather than the value that is below the threshold (lower index values represent newer measurements), but in other examples this decrement could be omitted. In block 608, if none of the acceleration values are determined to be above the threshold acceleration value al, then it is likely that a start has not taken place, perhaps due to an error in the pressure readings or the like. If however, an index i_{down}−1 is identified, then a determination is made that the elevator car 103 is in motion, and the position within the accelerometer data at which the motion started is identified in block 610 based on the identified index i_{down}−1 and the length of the buffer n as described previously. A motion status flag may then be set indicating that the elevator car 103 is in motion. In some examples, having identified the index i_{down}−1 at which the motion of the elevator car 103 began, the system waits until the identified index i_{down}−1 moves to the final position (n) of the buffer 227, and then changes the flag state from 0 to 1 (i.e. from “stationary” to “in motion”).

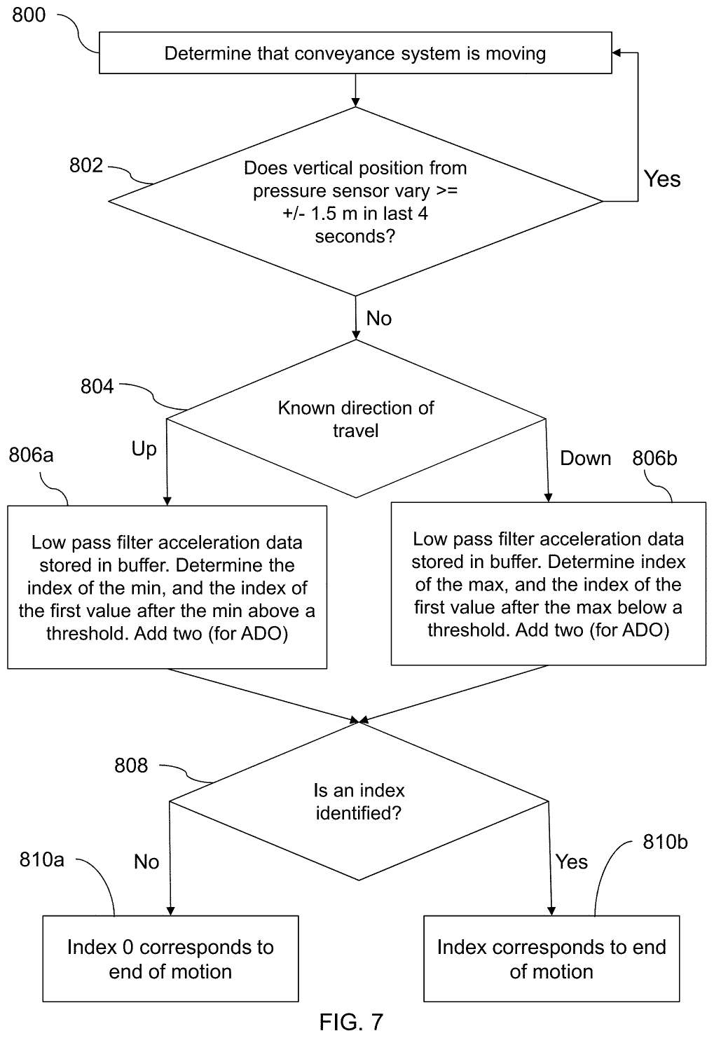

FIG. 7 shows a process for determining an end of motion of the elevator car 103 in accordance with the present disclosure. In block 800, it is determined that the elevator car 103 is moving (i.e. the motion status flag indicates that the elevator car 103 is in motion). In block 802, a change of pressure is determined by using the pressure sensor 228 of the sensor apparatus 210 as described previously. Based on the change of pressure, a change in height of the elevator car 103 is calculated. If the change of height in a given time is smaller than a threshold value (e.g. 1.5 metres within 4 seconds), the process continues to block 804. In block 804 the direction of travel is checked and used to determine the next step of the process. The direction of travel may be known from earlier processing, or may be determined based on, e.g. pressure or acceleration data prior to further steps being carried out.

If the known direction of travel is upwards the process continues to block 806a. However, if the known direction of travel is downwards, the process continues to block 806b. As noted previously, it will be appreciated that calculation of a change in height is not strictly required, and in some embodiments the measured change of pressure may be compared to a threshold in place of a change in height.

If the known direction of travel of the elevator car 103 is upwards, in block 806a, a low pass filter is applied to the acceleration measurements stored in the buffer 227. The index of the minimum acceleration value i_{min¬} is then identified. To determine the index associated with the end of motion, the acceleration measurements stored in the buffer 227 with an index lower than the index iₘᵢₙ of the minimum acceleration value (i.e. newer measurements) are compared to a threshold downward acceleration value a₁ (e.g. −10 mg) in order of decreasing index value. The index i*ᵤₚ of the first acceleration value greater than the threshold acceleration value a₁ is then identified, and the index i*ᵤₚ+2 is determined to be the index associated with the end of motion. The increment by 2 in this example is to move the identified position a bit earlier in the measurement history in order to take account of an advanced door opening feature. The value of “2” can be varied according to a particular implementation and may be established through analysis and optimisation to find the best value. In other examples, e.g. where there is no advanced door opening, this increment may be omitted (or may be a decrement instead). In block 808, if none of the acceleration values are determined to be above the threshold acceleration value a₁, then it is likely that something has gone wrong in the measurements or processing and so the system returns the motion state to zero (or “stationary”) immediately as this is the safest assumption. Thus, in this situation the process continues to block 810a, and a determination is effectively made that motion of the elevator car 103 ended exactly at index 0 (i.e. the most recent measurement corresponding to “now”). If however, an index i*ᵤₚ+2 is identified, then the process continues to block 810b. In block 810b a determination is made that the elevator car 103 is stationary, and the position within the accelerometer data at which the motion of the elevator car 103 ended is identified based on the identified index i*ᵤₚ+2. A motion status flag may then be set indicating that the elevator car 103 is stationary. In some examples, having identified the index i*ᵤₚ+2 at which the motion of the elevator car 103 stopped, the system waits until the identified index i*ᵤₚ+2 moves to the final position (n) of the buffer 227, and then changes the motion status flag from 1 to 0 (i.e. from “in motion” to “stationary”).

If the known direction of travel of the elevator car 103 is downwards, in block 806b, a low pass filter is applied to the acceleration measurements stored in the buffer 227. The index of the maximum acceleration value iₘₐₓ is then identified. To determine the index associated with the end of motion, the acceleration measurements stored in the buffer 227 with an index lower than the index iₘₐₓ of the maximum acceleration value (i.e. newer measurements) are compared to a threshold upward acceleration value a₁ (e.g. 10 mg) in order of decreasing index value. The index i*_{down} of the first acceleration value lower than the threshold acceleration value a₁ is then identified, and the index i*_{down}+2 is determined to be the index associated with the end of motion. The increment by 2 in this example is to move the identified position a bit earlier in the measurement history in order to take account of an advanced door opening feature. The value of “2” can be varied according to a particular implementation and may be established through analysis and optimisation to find the best value. In other examples, e.g. where there is no advanced door opening, this increment may be omitted (or may be a decrement instead). In block 808, if none of the acceleration values are determined to be below the threshold acceleration value a₁, then it is likely that something has gone wrong in the measurements or processing and so the system returns the motion state to zero (or “stationary”) immediately as this is the safest assumption. Thus, in this situation, the process continues to block 810a, and a determination is effectively made that that motion of the elevator car 103 ended exactly at index 0 (i.e. the most recent measurement corresponding to “now”). If however, an index i*_{down}+2 is identified, then the process continues to block 810b. In block 810b a determination is made that the elevator car 103 is stationary, and the position within the accelerometer data at which the motion of the elevator car 103 ended is identified based on the identified index i*_{down}+2. A motion status flag may then be set indicating that the elevator car 103 is stationary. In some examples, having identified the index i*_{down}+2 at which the motion of the elevator car 103 stopped, the system waits until the identified index i*_{down}+2 moves to the final position (n) of the buffer 227, and then changes the motion status flag from 1 to 0 (i.e. from “in motion” to “stationary”).

In this way, the processes described in FIGS. 6 and 7 can be used to accurately determine the time (or data index) at which a change in motion of the elevator car 103 occurred, and set a flag based on the motion of the elevator car 103 without requiring constant processing of accelerometer data. As processing of acceleration data is only carried out when the pressure sensor 228 identifies a change of position of the elevator car, these processes allow significant resource (e.g. power) conservation, and allow accurate determination of changes in car motion to be made.

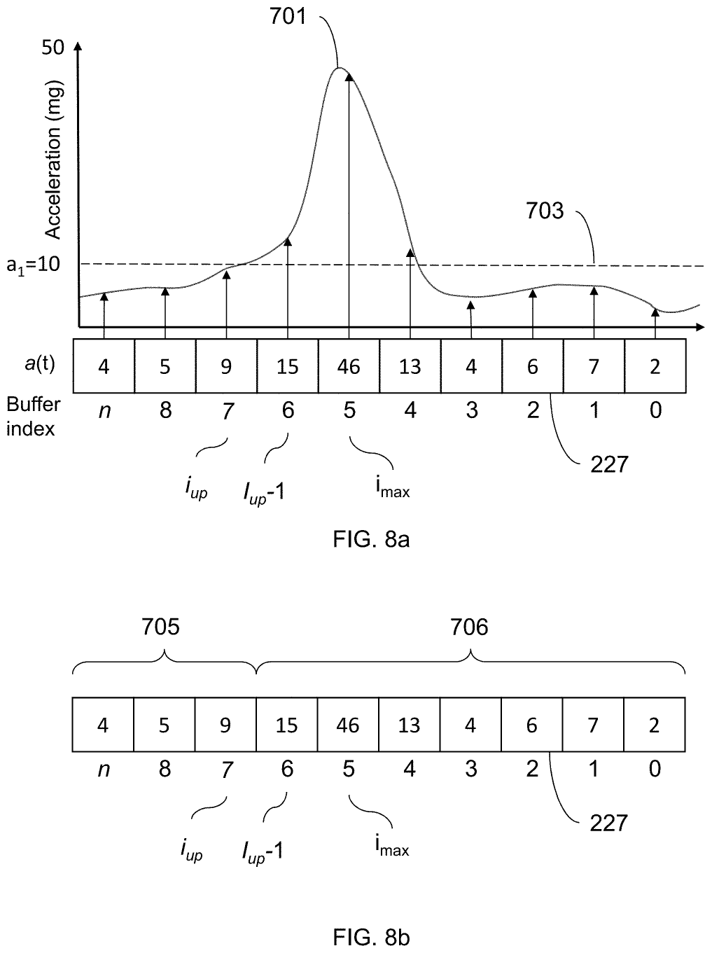

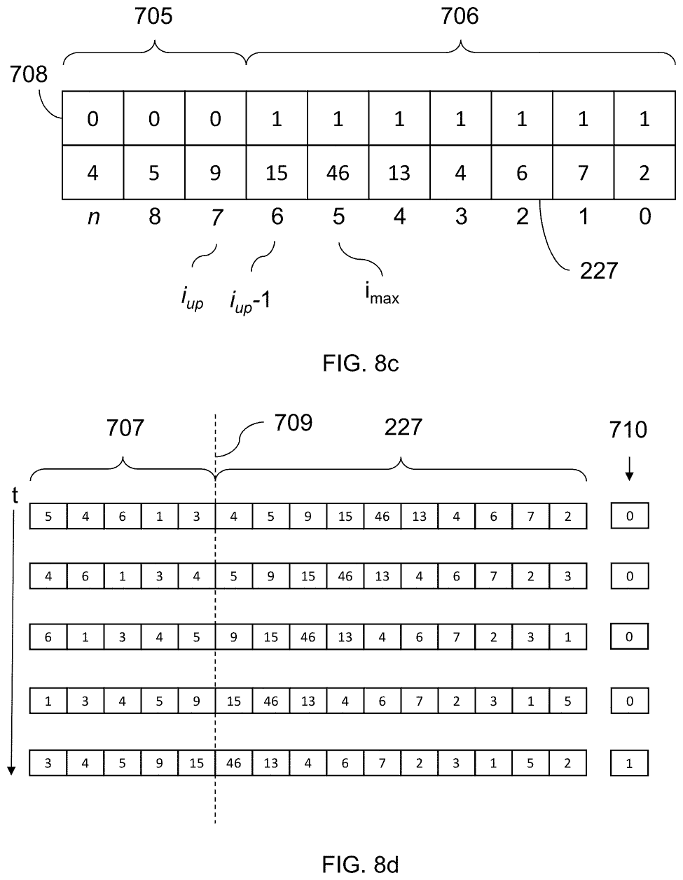

FIG. 8a shows an example of the low pass filtered acceleration values a(t) stored in a buffer 227 of length 10, and used in the determination of the start of motion in a vertically upward direction as described above in relation to FIG. 6. It should be understood that the example shown in FIG. 8 is purely illustrative, and that the acceleration values and buffer length shown are not necessarily representative of those expected to be used in practice. For example, in practice the buffer may be longer or may have a significantly finer time resolution than illustrated. In the example shown in FIG. 8a, the maximum acceleration value stored in the buffer 227, represented by peak 701, can be seen to have an index iₘₐₓ=5. The threshold acceleration value a₁ is shown by dashed line 703. The first acceleration value with size smaller than the threshold acceleration value a₁ can therefore be seen to have index iᵤₚ=7. The start of upward motion is then determined to have occurred at index iᵤₚ−1=6. Based on this determination, a motion status flag can be set indicating that buffer values having index greater than iᵤₚ−1 are associated with a stationary elevator car (and hence are likely to be related to motion of, e.g. the elevator car doors 104), while buffer values having index less than or equal to iᵤₚ−1 are associated with motion of the elevator car 103 itself. This segregation of data is illustrated in FIG. 8b which shows a first group 705 of data points (older than iᵤₚ−1) identified as belonging to door motion (stationary elevator car 103) and a second group 706 of data points (iᵤₚ−1 and newer) identified as belonging to a moving elevator car 103.

FIGS. 8c and 8d show two ways in which a motion status flag indicating the state of motion of the elevator car 103 may be set after a change in motion of the elevator car 103 has been determined, and the associated index value (iᵤₚ−1) has been identified.

FIG. 8c illustrates a first method for setting a flag 708 indicating the state of motion of the elevator car 103. In the method illustrated by FIG. 8c, each accelerometer data value has an associated flag value 708 indicating whether the elevator car 103 was in motion (flag 708 is set to 1) or stationary (flag 708 is set to 0) at the time of that acceleration value. Such data could be stored and processed in bulk at a later time while retaining accurate knowledge of which data points correspond to which motion state.

FIG. 8d illustrates a second method of setting a flag indicating the state of motion of the elevator car 103, in which a flag 710 is set once a change of motion of the elevator car 103 has been identified as having occurred a fixed time ago (therefore allowing delayed processing with a fixed time delay). FIG. 8d shows a series of five successive snapshots in time of the accelerometer data, each snapshot having acquired a new data sample relative to the snapshot above. In the first (uppermost) set of values shown in FIG. 8d, the buffer 227 can be seen to contain 10 values, corresponding to the 10 most recent acceleration values shown in FIG. 8a. The end of the buffer 227 (indicated by dashed line 709) is also shown in FIG. 8d, in addition to older values 707 which are no longer stored within the buffer 227. In the uppermost line of FIG. 8d the older values 707 correspond to a time when the elevator car 103 was known to be stationary, and hence at this time, the flag 710 is set to 0. As each new value is saved to the buffer 227 (in position 0 at the right hand end), the other acceleration measurements are shifted left (index increased by one), and the oldest value within the buffer 227 (having index value i=9 in this example) is removed from the buffer 227. In the example shown in FIG. 8d, the index value associated with a change of motion (iᵤₚ−1) is initially identified at position 6 of the buffer 227. When this value passes beyond the final entry in the buffer 227 (i.e. has an index entry greater than n), the flag 710 is changed from 0 to 1 to indicate that the elevator car 103 was in motion at a fixed time in the past, the fixed time corresponding to the length of the buffer 227. In FIG. 8d this happens in the final (fifth) line when the value “15” from original index 6 (in the first line) has shifted left of the dashed line 709. The flag 710 then remains set at 1 until it is determined that the elevator car 103 is stationary again, i.e. until an end of motion of the elevator car 103 is identified as was described above in relation to FIG. 7. As can be seen from FIG. 8d, this processing can be done in real time with only a single bit flag 710 and without having to store the flag in association with the data. The motion status for the older data 707 is known with accuracy and therefore this data 707 can be processing with a time delay equal to the length of the buffer 227 and using the flag 710 to indicate changes in the motion state associated with that data 707. The flag 710 will reliably indicate the motion state of the elevator car 103 associated with the most recent of the older data points 707.

It will be appreciated by those skilled in the art that the disclosure has been illustrated by describing one or more specific examples thereof, but is not limited to these examples; many variations and modifications are possible, within the scope of the accompanying claims.

What is claimed is:

1. A monitoring system for a conveyance system, comprising:
a pressure sensor mounted on a conveyance apparatus;
an accelerometer mounted on the conveyance apparatus; and
a controller arranged to:
acquire accelerometer data by sampling the accelerometer;
store the accelerometer data in a buffer;
acquire pressure sensor data by sampling the pressure sensor;
determine from the pressure sensor data that a start or stop of the conveyance apparatus has occurred; and
upon said determination, analyse the accelerometer data to determine a first position within the accelerometer data, wherein the first position is a position at which the start or stop of the conveyance apparatus occurred.

2. A monitoring system as claimed in claim 1, wherein the controller is arranged to determine that a start or stop of the conveyance apparatus has occurred based on detecting a change in the pressure data of at least a threshold amount within a predetermined period of time.

3. A monitoring system as claimed in claim 1, wherein the controller is arranged to analyse a recent time window of the accelerometer data.

4. A monitoring system as claimed in claim 1, wherein the controller is arranged to filter the accelerometer data with a low pass filter.

5. A monitoring system as claimed in claim 1, wherein the controller is arranged to analyse the accelerometer data to find a second position within the accelerometer data, the second position being a position at which the accelerometer data crosses a threshold value and wherein the controller is arranged to determine the first position based on the second position.

6. A monitoring system as claimed in claim 1, wherein the controller is arranged to analyse the accelerometer data to find a third position within the accelerometer data, the third position being a position at which the accelerometer data reaches a maximum or minimum value and wherein the controller is arranged to determine the first position based on the third position.

7. A monitoring system as claimed in claim 1, wherein the controller is arranged to associate a motion state of the conveyance apparatus with the accelerometer data, the motion state being an indication of whether the conveyance apparatus is in motion or stationary.

8. A monitoring system as claimed in claim 1, wherein the controller is arranged to segregate the accelerometer data into two or more groups based on the first position.

9. A monitoring system as claimed in claim 1, wherein the controller is arranged to process the accelerometer data to analyse the health of the conveyance system, wherein said processing is performed with a fixed time delay, and wherein the controller is arranged to change a type of health analysis when the first position in the accelerometer data corresponds to the fixed time delay.

10. A monitoring system as claimed in claim 9, wherein the conveyance system is an elevator system and wherein the controller is arranged to change the type of health analysis from elevator door analysis to elevator car analysis or from elevator car analysis to elevator door analysis.

11. A monitoring system as claimed in claim 1, wherein the conveyance system is an elevator system and the conveyance apparatus is an elevator car, wherein the elevator system implements an advanced door opening system and wherein when the controller determines a stop of the elevator car, the controller is arranged to determine the first position within the accelerometer data additionally based upon an advanced door opening adjustment.

12. A monitoring system as claimed in claim 1, wherein the monitoring system is powered by a battery or energy harvesting system.

13. A monitoring system as claimed in claim 1, wherein the monitoring system is independent from the conveyance system.

14. A monitoring system as claimed in claim 1, wherein a sampling rate of the accelerometer is greater than a sampling rate of the pressure sensor.

15. A method of monitoring a conveyance system, comprising:
acquiring accelerometer data by sampling an accelerometer on a conveyance apparatus;
storing the accelerometer data in a buffer;
acquiring pressure sensor data by sampling a pressure sensor on the conveyance apparatus;
determining from the pressure sensor data that a start or stop of the conveyance apparatus has occurred; and
upon said determination, analysing the accelerometer data to determine a first position within the accelerometer data, wherein the first position is a position at which the start or stop of the conveyance apparatus occurred.
